(19) United States
(12) Patent Application Publication
(10) Pub. No.: US 2015/0346643 A1
(43) Pub. Date: Dec. 3, 2015

(54) TRANSFER ASSEMBLY AND IMAGE FORMING APPARATUS INCLUDING SAME

(71) Applicants: Takahiro KONISHI, Kanagawa (JP); Ryo Hasegawa, Kanagawa (JP); Kazuosa Kuma, Kanagawa (JP); Susumu Mikajiri, Tokyo (JP); Marutomo Goto, Kanagawa (JP); Haruki Nagata, Kanagawa (JP)

(72) Inventors: Takahiro KONISHI, Kanagawa (JP); Ryo Hasegawa, Kanagawa (JP); Kazuosa Kuma, Kanagawa (JP); Susumu Mikajiri, Tokyo (JP); Marutomo Goto, Kanagawa (JP); Haruki Nagata, Kanagawa (JP)

(21) Appl. No.: 14/723,767

(22) Filed: May 28, 2015

(30) Foreign Application Priority Data
May 30, 2014 (JP) 2014-111981

(51) Int. Cl. G03G 15/16

(52) U.S. Cl. CPC G03G 15/161

(57) ABSTRACT

The transfer assembly includes a belt, a transfer device, a contact-and-separation device including a retainer, and a first vibration absorber. The transfer device contacts an image bearer via the belt to form a transfer nip portion between the image bearer and the belt and to transfer the toner image onto one of a surface of the belt and a recording medium carried on the surface of the belt. The contact-and-separation device moves the transfer device to contact and separate from the image bearer. The retainer is pivotally supported by a swingable shaft and movable in a first direction in which the transfer device approaches the image bearer and in a second direction opposite to the first direction in which the transfer device separates from the image bearer, to hold the transfer device. The first vibration absorber absorbs vibration transmitted from the swingable shaft to the transfer device via the retainer.

### CROSS-REFERENCE TO RELATED APPLICATIONS

This patent application is based on and claims priority pursuant to 35 U.S.C. §119 to Japanese Patent Application No. 2014-111981, filed on May 30, 2014 in the Japan Patent Office, the entire disclosure of which is hereby incorporated by reference herein.

### BACKGROUND

1. Technical Field

Exemplary aspects of the present disclosure generally relate to a transfer assembly and an image forming apparatus including the transfer assembly, and more particularly to an image forming apparatus such as a copier, a facsimile machine, a printer, or a multi-functional system including a combination thereof.

2. Description of the Related Art

There is known a tandem-type color image forming apparatus in which a plurality of photoconductors are arranged in tandem facing an intermediate transfer belt entrained around and stretched taut between a plurality of support rollers. Toner images are formed on the photoconductors and transferred primarily onto the intermediate transfer belt one atop the other, forming a composite toner image in a primary transfer process. Subsequently, the composite toner image is transferred onto a recording medium in a secondary transfer process. The tandem-type image forming apparatus is known to be capable of transferring the composite toner image onto a recording medium relatively fast, and hence this type of image forming apparatus is widely used.

In the image forming apparatus of this type, the intermediate transfer belt is rotatably entrained about the plurality of support rollers each of which is disposed facing the front surface or the image bearing surface of the intermediate transfer belt. Primary transfer rollers are disposed opposite the photoconductors with the intermediate transfer belt interposed therebetween, thereby forming primary transfer nips at which the primary transfer rollers contact the photoconductors via the intermediate transfer belt. The toner images are transferred from the photoconductors onto the intermediate transfer belt in the primary transfer nips.

### SUMMARY

In view of the foregoing, in an aspect of this disclosure, there is provided an improved transfer assembly including a belt, a transfer device, a contact-and-separation device including a retainer, and a first vibration absorber. The belt is formed into an endless loop facing an image bearer bearing a toner image and rotates. The transfer device contacts the image bearer via the belt to form a transfer nip portion between the image bearer and the belt and to transfer the toner image onto one of a surface of the belt and a recording medium carried on the surface of the belt. The contact-and-separation device moves the transfer device to contact and separate from the image bearer. The retainer holds the transfer device and is pivotally supported by a swingable shaft and movable in a first direction in which the transfer device approaches the image bearer and in a second direction opposite to the first direction in which the transfer device separates from the image bearer. The first vibration absorber absorbs vibration transmitted from the swingable shaft to the transfer device via the retainer.

According to another aspect, an image forming apparatus includes an image bearer, a belt, a transfer roller, a swingable shaft, a bracket, and a grease. The image bearer bears a toner image on a surface of the image bearer. The belt is disposed opposite to the image bearer. The transfer roller contacts a rear surface of the belt to transfer the toner image from the image bearer onto a front surface of the belt. The bracket includes a shaft hole through which the swingable shaft is inserted and holds the transfer roller pivotally movable about the swingable shaft such that the transfer roller is pivotally movable between a contact position at which the transfer roller contacts the rear surface of the belt and a separating position at which the transfer roller is separated from the belt. The separation position is a direction opposite to the contact direction. The grease fills in a space between an outer circumferential surface of the swingable shaft and an inner circumferential surface of the shaft hole.

According to another aspect, an image forming apparatus includes an image bearer, a belt, a transfer roller, a swingable shaft, a bracket, and a rubber. The image bearer bears a toner image on a surface of the image bearer. The belt is disposed opposite to the image bearer. The transfer roller contacts a rear surface of the belt to transfer the toner image from the image bearer onto a front surface of the belt. The bracket includes a shaft hole through which the swingable shaft is inserted and holds the transfer roller pivotally movable about the swingable shaft such that the transfer roller is pivotally movable between a contact position at which the transfer roller contacts the rear surface of the belt and a separating position at which the transfer roller is separated from the belt. The separation position is a direction opposite to the contact direction. The rubber is disposed between an outer circumferential surface of the swingable shaft and an inner circumferential surface of the shaft hole.

The aforementioned and other aspects, features and advantages would be more fully apparent from the following detailed description of illustrative embodiments, the accompanying drawings and the associated claims.

### BRIEF DESCRIPTION OF THE SEVERAL VIEWS OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1A is a schematic diagram illustrating a first vibration absorber that absorbs vibration transmitted from a fulcrum shaft to a roller support bracket according to an illustrative embodiment of the present disclosure;

FIG. 1B is a schematic diagram illustrating a second vibration absorber that absorbs vibration transmitted from the roller support bracket to a roller shaft of a transfer roller;

FIG. 2 is a schematic diagram illustrating an image forming apparatus according to an illustrative embodiment of the present disclosure;

FIG. 3 is a perspective view schematically illustrating an intermediate transfer device and photoconductors employed in the image forming apparatus of FIG. 2 according to an illustrative embodiment of the present disclosure;

FIG. 4 is an enlarged perspective view schematically illustrating one of primary transfer portions defined by a primary transfer roller and a photoconductor employed in the image forming apparatus;

FIG. 5 is a partially enlarged cross-sectional view schematically illustrating the primary transfer portion as viewed from an axis of the primary transfer roller;

FIG. 6 is a partially enlarged cross-sectional view schematically illustrating the primary transfer roller separated from the photoconductor;

FIG. 7 is a partially enlarged schematic diagram illustrating a third vibration absorber disposed at a connecting portion at which one end of a tension spring and a roller support bracket are connected;

FIG. 8 is a graph showing measurement results of vibration of the roller support bracket when the intermediate transfer device is shaken at 105 Hz in a state in which grease as the vibration absorber is not applied to the fulcrum shaft;

FIG. 9 is a graph showing measurement results of vibration of the roller support bracket when the intermediate transfer device is shaken at 105 Hz in a state in which grease having a kinematic viscosity of 390 cSt (centistoke) at 40° C. as the vibration absorber is applied to the fulcrum shaft;

FIG. 10 is a graph showing fast Fourier transform (FFT) analysis of changes in luminance of an output image when the intermediate transfer device is shaken at 105 Hz in a state in which the grease is not applied to the fulcrum shaft; and

FIG. 11 is a graph showing the FFT analysis of changes in luminance of an output image when the intermediate transfer device is shaken at 105 Hz in a state in which the grease is applied to the fulcrum shaft.

### DETAILED DESCRIPTION

A description is now given of illustrative embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of this disclosure.

In addition, it should be noted that the terminology used herein is for the purpose of describing particular embodiments only and is not intended to be limiting of this disclosure. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In a later-described comparative example, illustrative embodiment, and alternative example, for the sake of simplicity, the same reference numerals will be given to constituent elements such as parts and materials having the same functions, and redundant descriptions thereof omitted.

Typically, but not necessarily, paper is the medium from which is made a sheet on which an image is to be formed. It should be noted, however, that other printable media are available in sheet form, and accordingly their use here is included. Thus, solely for simplicity, although this Detailed Description section refers to paper, sheets thereof, paper feeder, etc., it should be understood that the sheets, etc., are not limited only to paper, but include other printable media as well.

Referring now to the drawings, wherein like reference numerals designate identical or corresponding parts throughout the several views, exemplary embodiments of the present patent application are described.

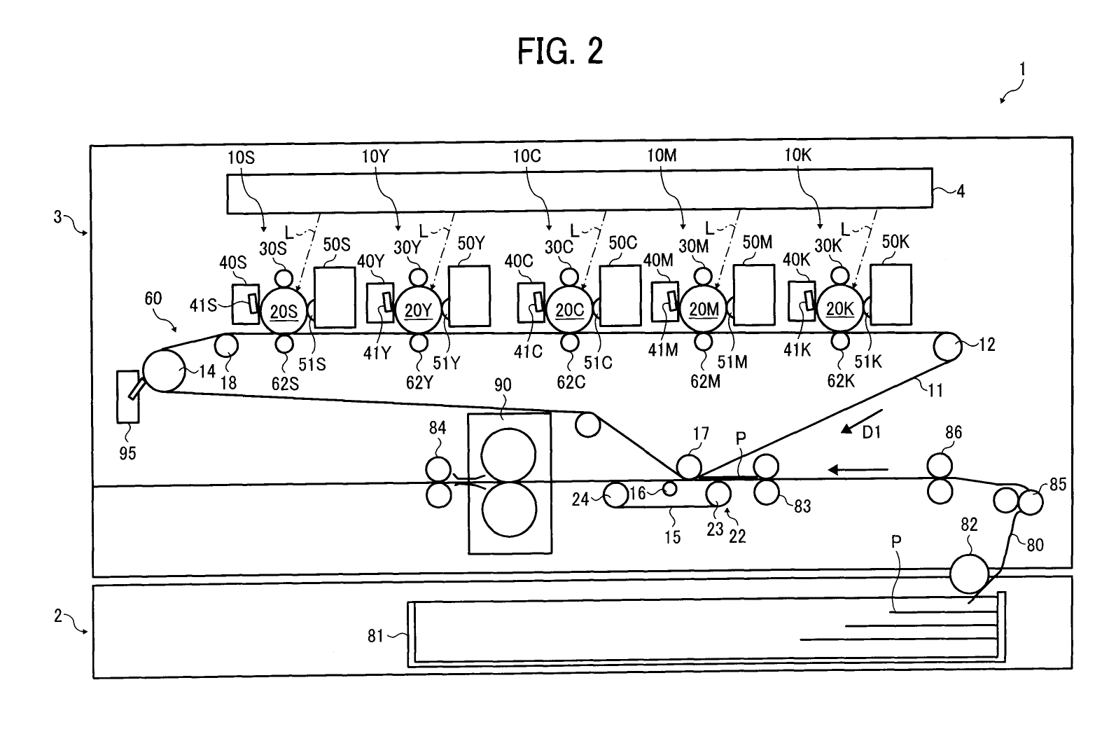

FIG. 2 is a schematic diagram illustrating an example of an image forming apparatus according to an illustrative embodiment of the present disclosure. As illustrated in FIG. 2, an image forming apparatus 1 is a tandem-type image forming apparatus in which an image forming stations 10S, 10Y, 10C, 10M, and 10K are arranged in tandem. The image forming stations 10S, 10Y, 10C, 10M, and 10K constitute an image forming unit 3 and can be used as process cartridges. Toner images formed by the image forming stations 10S, 10Y, 10C, 10M, and 10K are transferred onto an intermediate transfer belt 11 serving as a transfer device one atop the other, forming a composite toner image which is then transferred onto a recording medium P.

As illustrated in FIG. 2, the image forming apparatus 1 includes, e.g., the image forming unit 3 to form the toner images and a paper feed unit 2 to store and supply recording media P.

The image forming unit 3 includes the image forming stations 10Y, 10C, 10M, and 10K, one for each of the colors yellow (Y), cyan (C), magenta (M), and black (K), respectively. The image forming unit 3 also includes the image forming station 10S for a colorless, transparent or clear toner. It is to be noted that the suffixes S, Y, C, M, and K denote clear, yellow, cyan, magenta, and black, respectively. These suffixes are omitted, unless the discrimination of the colors is necessary. The image forming stations 10S, 10Y, 10C, 10M, and 10K are arranged in tandem horizontally.

When the clear toner S is coated on image surfaces with color toners such as yellow, cyan, magenta, and black, the clear toner S on the image surfaces functions as an overcoat layer and protects the image surfaces. Furthermore, when forming a pattern on a recording medium P with a smooth surface using the clear toner S, it produces a luxurious or special texture such as fancy paper.

It is to be noted that the position of the image forming station 10S for the clear toner S is not limited to the position shown in FIG. 2. Furthermore, a white toner may be used instead of the clear toner S.

In a configuration in which the white toner is used, a transparent sheet is used as a recording medium P, and a color toner image is formed on the image bearing surface of the transparent sheet using at least one of the color toners yellow, cyan, magenta, and black. Subsequently, the white toner is used to form a white toner image on top of the color toner image. With this configuration, as the color toner image is viewed from the opposite side of the image bearing surface of the transparent sheet, the color toner image is not seen through, and the gloss finish of the transparent sheet provides a uniformly-glossy print with an added value.

An exposure device 4 is disposed substantially at the upper portion of the image forming stations 10S, 10Y, 10C, 10M, and 10K. The exposure device 4 exposes the surface of each of the photoconductors 20S, 20Y, 20C, 20M, and 20K based on image data for each color to form an electrostatic latent image on each of surfaces of the photoconductors 20S, 20Y, 20C, 20M, and 20K.

An intermediate transfer assembly 60 is disposed substantially below the image forming stations 10S, 10Y, 10C, 10M, and 10K. The intermediate transfer assembly 60 includes an intermediate transfer belt 11 formed into an endless loop and rotatably entrained about a plurality of rollers: a drive roller 12, a tension roller 14, a driven roller 18, and so forth.

The image forming stations 10S, 10Y, 10C, 10M, and 10K all have the same configuration as all the others, differing only in the color of toner employed. Thereafter, the suffixes S, Y, C, M, and K indicating colors are omitted herein, unless otherwise specified.

Each of the image forming stations 10 includes the photoconductor 20 serving as an image bearing member, a charging roller 30 (i.e., 30S, 30Y, 30C, 30M, 30K) serving as a charger to charge the surface of the photoconductor 20, and a developing device 50 (i.e., 50S, 50Y, 50C, 50M, 50K) to develop an electrostatic latent image formed on the photoconductor 20 with toner of respective color. The surface of the photoconductor 20 is charged by the charging roller 30 and illuminated with laser light L irradiated from the exposure device 4 serving as a latent image forming device, thereby forming an electrostatic latent image on the surface of the photoconductor 20. Then, the electrostatic latent image formed on the photoconductor 20 is developed with toner by the developing device 50.

Furthermore, the image forming station 10 includes a photoconductor cleaner 40 (i.e., 40S, 40Y, 40C, 40M, 40K) equipped with a cleaning blade 41 (i.e., 41S, 41Y, C, 41M, 41K) to clean the surface of the photoconductor 20 after the toner image is transferred from the photoconductor 20 onto the intermediate transfer belt 11.

The charging roller 30 is connected to a power source and supplied with a predetermined charging bias in which a bias having an alternating current component is superimposed on a direct current component. The charging roller 30 is disposed opposite the photoconductor 20 with a slight gap therebetween. Alternatively, the charging roller 30 and the photoconductor 20 contact each other.

The developing device 50 contains a two-component developing agent (hereinafter referred to simply as a developer) including magnetic carrier particles and toner particles. The developing device 50 is disposed facing the photoconductor 20 to develop the electrostatic latent image on the surface of the photoconductor 20.

The developing device 50 includes a developing roller 51 (i.e., 51S, 51Y, 51C, 51M, 51K) serving as a developer bearer. The developer carried by the developing roller 51 is adjusted to a developer layer with a predetermined thickness by a developer adjuster. Subsequently, the developer is delivered to a position opposite to the photoconductor 20. The toner particles in the developer carried on the developing roller 51 are adhered to the electrostatic latent image formed on the photoconductor 20.

Toner bottles are disposed in the image forming apparatus 1 to supply toner to the developing devices 50S, 50Y, 50C, 50M, and 50K. The toner of respective color is supplied to the developing devices 50S, 50Y, 50C, 50M, and 50K as needed via toner conveyor paths.

The intermediate transfer assembly 60 includes the intermediate transfer belt 11 formed into an endless loop and rotatably entrained about the drive roller 12, the tension roller 14, and the driven roller 18. Furthermore, the intermediate transfer assembly 60 includes primary transfer rollers 62S, 62Y, 62C, 62M, and 62K to primarily transfer toner images from the photoconductors 20S, 20Y, 20C, 20M, and 20K onto the intermediate transfer belt 11.

The primary transfer rollers 62S, 62Y, 62C, 62M, and 62K are disposed inside the looped intermediate transfer belt 11, opposite to the photoconductors 20S, 20Y, 20C, 20M, and 20K, respectively. The primary transfer rollers 62S, 62Y, 62C, 62M, and 62K are connected to a power source and supplied with a predetermined primary transfer bias.

A secondary transfer unit 22 is disposed opposite the image forming unit 3 via the intermediate transfer belt 11. The secondary transfer unit 22 includes a secondary transfer roller 16, support rollers 23 and 24, and a secondary transfer belt 15. In the secondary transfer unit 22, the secondary transfer belt 15 is formed into an endless loop and rotatably entrained about the secondary transfer roller 16 and the support rollers 23 and 24.

The secondary transfer belt 15 is pressed against a secondary-transfer opposed roller 17 via the intermediate transfer belt 11 at a position at which the intermediate transfer belt 11 is supported by the secondary transfer roller 16. A secondary transfer nip serving as a secondary transfer portion is formed between the secondary transfer belt 15 and the intermediate transfer belt 11. Similar to the primary transfer rollers 62S, 62Y, 62C, 62M, and 62K, the secondary transfer roller 16 is connected to a power source and supplied with a predetermined secondary transfer bias.

A belt cleaning device 95 is disposed opposite the tension roller 14 via the intermediate transfer belt 11 to clean the surface of the intermediate transfer belt 11 after the secondary transfer process. Furthermore, the image forming apparatus 1 includes a lubricating agent applicator to apply a lubricating agent to the intermediate transfer belt 11.

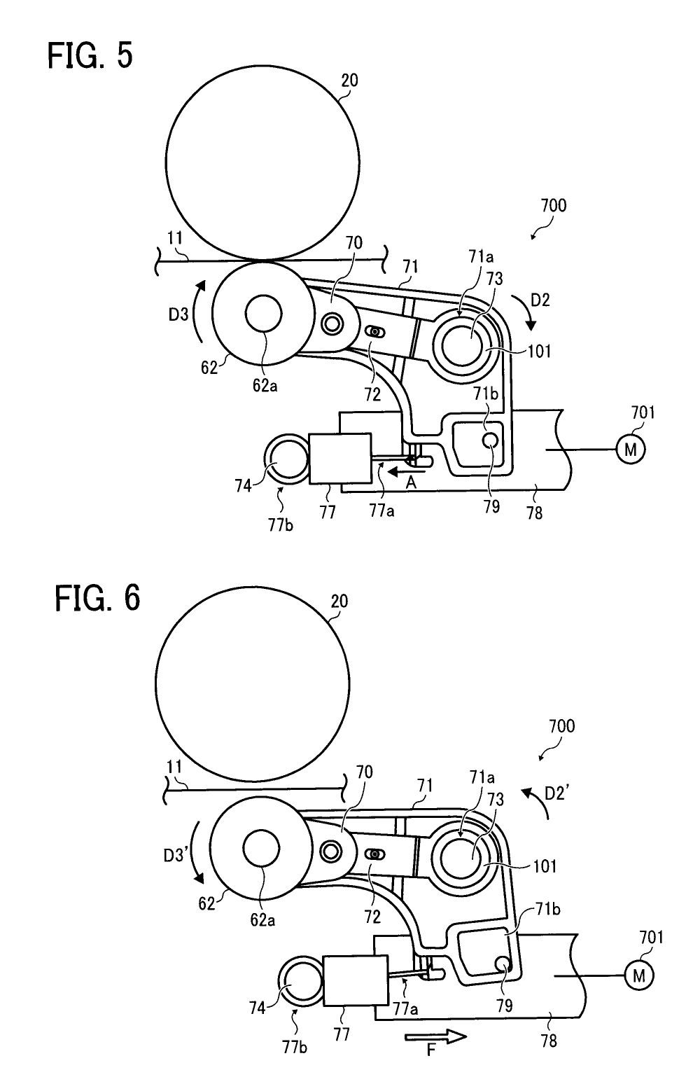

According to the present illustrative embodiment, the image forming apparatus 1 includes a contact-and-separation device 700 (shown in FIG. 5) including a slider 78 and a pin 79 to cause the photoconductors 20S, 20Y, 20C, 20M, and 20K of the image forming stations 10S, 10Y, 10C, 10M, and 10K, and the intermediate transfer belt 11 to contact and separate from each other. More specifically, the contact-and-separation device 700 of the present illustrative embodiment moves the primary transfer rollers 62, which support the intermediate transfer belt 11 from the inner circumferential surface thereof, in directions in which the primary transfer rollers 62 contact and separate from the photoconductors 20.

As illustrated in FIG. 2, the paper feed unit 2 is disposed substantially at the bottom of the image forming apparatus 1. The paper feed unit 2 includes a paper cassette 81 storing a bundle of recording media sheets P and a feed roller 82. The feed roller 82 contacts the top sheet of the bundle of the recording media P. As the feed roller 82 is rotated by a driving device, the top sheet is fed to a paper path 80 in the image forming apparatus 1.

The recording medium P fed to the paper path 80 is delivered along the paper path 80 by conveyor roller pairs 85 and 86 disposed in the paper path 80, and the leading end of the recording medium P is interposed between a pair of registration rollers 83. As the leading end of the recording medium P is interposed between the pair of registration rollers 83, the pair of registration rollers 83 starts to rotate in appropriate timing to feed the recording medium P to a later-described secondary transfer nip.

A fixing device 90 is disposed downstream from the secondary transfer nip in the direction of paper conveyance. The fixing device 90 fixes the toner image on the recording medium P. The fixing device 90 includes a fixing roller and a pressing roller. The fixing roller includes a heat source such as a halogen heater inside the fixing roller. The pressing roller pressingly contacts the fixing roller.

In order to facilitate an understanding of the novel features of the present invention, as a comparison, a description is provided of a comparative example of an image forming apparatus.

In the comparative example of the image forming apparatus, primary transfer rollers are held by a bracket disposed on a contact-and-separation device that moves the intermediate transfer belt to contact and separate from the photoconductors. The bracket is pivotally disposed on a swingable shaft fixed to a housing of a transfer assembly. The swingable shaft is parallel to the axis of the primary transfer rollers.

The contact-and-separation device moves the bracket pivotally about the swingable shaft with a drive force from the driving device of the contact-and-separation device so as to move the primary transfer rollers to contact and separate from the photoconductors, thereby changing the track of the intermediate transfer belt. In other words, the intermediate transfer belt is moved to contact and separate from the photoconductors.

Vibration in the image forming apparatus, for example, vibration generated by the driving device for rotating the intermediate transfer belt and by the driving device of the contact-and-separation device, vibrates the housing of the transfer assembly. When the vibration of the housing transmits to the swingable shaft, the vibration transmits to the primary transfer rollers via the bracket, hence shaking the primary transfer rollers. As a result, the transfer pressure in the primary transfer nips changes, resulting in image defects such as unevenness in an output image.

Generally, when such vibration occurs, the cause of vibration is specified to prevent transmission of the vibration to the bracket via the swingable shaft and to prevent the housing itself from shaking. However, the vibration has multiple frequencies with different sources of vibration. Thus, it takes time to pinpoint the source of each vibration and prevention, requiring complicated operation.

Similar difficulty occurs in a direct-transfer type image forming apparatus in which a toner image is directly transferred from the photoconductor onto a recording medium carried on the surface of a transfer-conveyor belt.

Referring now to FIG. 2, a description is provided of image forming operations according to the illustrative embodiment of the present disclosure.

The contact-and-separation device 700 is controlled in accordance with image forming modes. More specifically, the contact-and-separation device 700 enables the intermediate transfer belt 11 and the photoconductor 20 which is used in the selected image forming mode to contact each other. By contrast, the contact-and-separation device 700 separates the intermediate transfer belt 11 and the photoconductor 20 which is not used in the selected image forming mode from each other.

The photoconductor 20 contacting the intermediate transfer belt 11 is rotated in a counterclockwise direction by a driving device. The surface of the photoconductor 20 rotated by the driving device is charged uniformly by the charging roller 30 to a predetermined polarity. The charged surface of the photoconductor 20 is irradiated with scan light from the exposure device 4 to form an electrostatic latent image on the surface of the photoconductor 20. The electrostatic latent image formed on the photoconductor 20 is developed with a toner of respective color by the developing device 50 into a visible image, known as a toner image.

The intermediate transfer belt 11 is driven to rotate in a clockwise direction indicated by arrow D1 in FIG. 2 as the photoconductor 20 rotates. The primary transfer roller 62 transfers primarily the toner image formed on the photoconductor 20 onto the intermediate transfer belt 11. More specifically, the toner images formed on each of the photoconductors 20 are transferred primarily onto the intermediate transfer belt 11 such that they are superimposed one atop the other, thereby forming a composite toner image.

The recording medium P is fed from the paper cassette 81 by the feed roller 82. When the leading edge of the recording medium P arrives at the pair of the registration rollers 83 and a paper detector detects the recording medium P, rotation of the registration rollers 83 is stopped temporarily and then rotated again based on a detection signal provided by the paper detector to feed the recording medium P to the secondary transfer nip in appropriate timing. The secondary transfer nip is a place of contact between the secondary transfer belt 15 and the intermediate transfer belt 11.

Due to a secondary transfer bias applied to the secondary transfer roller 16, a potential difference is formed between the secondary-transfer opposed roller 17 and the secondary transfer roller 16, thereby forming an electric field in the secondary transfer nip. Accordingly, the composite toner image is transferred secondarily from the intermediate transfer belt 11 onto the recording medium P in the secondary transfer process.

After the composite toner image is transferred onto the recording medium P in the secondary transfer nip, the recording medium P is delivered to the fixing device 90 and heat and pressure are applied to the recording medium P while the recording medium P passes through the fixing device 90. Accordingly, the composite toner image is fixed on the recording medium P in a fixing process. After the composite toner image is fixed on the recording medium P in the fixing process, the recording medium P is discharged onto an output tray disposed outside the image forming apparatus 1 by a pair of output rollers 84 disposed downstream from the fixing device 90. This completes a series of image forming operations for a sheet of recording medium P.

After the toner image is primarily transferred onto the intermediate transfer belt 11, residual toner remaining on the surface of the photoconductors 20S, 20Y, 20C, 20M, and 20K is removed and collected by the photoconductor cleaners 40S, 40Y, 40C, 40M, and 40K, respectively. The collected residual toner is delivered to a waste toner bin. After the surface of the photoconductors 20S, 20Y, 20C, 20M, and 20K is cleaned by the photoconductor cleaners 40S, 40Y, 40C, 40M, and 40K, residual charge remaining on the photoconductors 20S, 20Y, 20C, 20M, and 20K is removed, and in the meantime the photoconductors 20S, 20Y, 20C, 20M, and 20K are charged by the charging rollers 30S, 30Y, 30C, 30M, and 30K in preparation for the subsequent imaging cycle.

Residual toner remaining on the intermediate transfer belt 11 is cleaned by the belt cleaning device 95 in preparation for the subsequent imaging cycle.

According to the present illustrative embodiment, the image forming apparatus 1 is capable of carrying out five different imaging modes: a full-color mode, a monochrome mode, a special color mode, a combination mode which is a combination of the full-color mode and the special color mode, and a lubricating-agent application mode.

More specifically, in the full-color mode, a full-color image is formed using toners in yellow (Y), magenta (M), cyan (C), and black (K).

In the full-color mode, the primary transfer rollers 62Y, 62C, 62M, and 62K are situated near the photoconductors 20Y, 20C, 20M, and 20K, respectively, by the contact-and-separation device 700, thereby moving the intermediate transfer belt 11 to contact the photoconductors 20Y, 20C, 20M, and 20K.

In the image forming station 10S, which is not used in the full-color mode, the primary transfer roller 62S is situated away from the photoconductor 20S by the contact-and-separation device 700, thereby separating the intermediate transfer belt 11 from the photoconductor 20S.

In the monochrome mode, a monochrome image is formed using a black toner. In the monochrome mode, the primary transfer roller 62K is situated near the photoconductor 20K by the contact-and-separation device 700, moving the intermediate transfer belt 11 to contact the photoconductor 20K.

In the image forming stations 10S, 10Y, 10C, and 10M, which are not used in the monochrome mode, the primary transfer rollers 62S, 62Y, 62C, and 62M are situated away from the photoconductors 20S, 20Y, 20C, and 20M by the contact-and-separation device 700. Accordingly, the intermediate transfer belt 11 and the photoconductors 20S, 20Y, 20C, and 20M are separated.

In the special color mode, an image is formed using the clear toner S. In the special color mode, the primary transfer roller 62S is situated near the photoconductor 20S by the contact-and-separation device 700, moving the intermediate transfer belt 11 to contact the photoconductor 20S.

In the image forming stations 10Y, 10C, 10M, and 10K, which are not used in the special color mode, the primary transfer rollers 62Y, 62C, 62M, and 62K are situated away from the photoconductors 20Y, 20C, 20M, and 20K by the contact-and-separation device 700. Accordingly, the intermediate transfer belt 11 and the photoconductors 20Y, 20C, 20M, and 20K are separated.

In the combination mode, an image is formed using all the image forming stations 10S, 10Y, 10M, 10C, and 10K. In the combination mode, the primary transfer rollers 62S, 62Y, 62C, 62M, and 62K are situated near the photoconductors 20S, 20Y, 20C, 20M, and 20K, respectively, by the contact-and-separation device 700. Accordingly, the intermediate transfer belt 11 and the photoconductors 20S, 20Y, 20C, 20M, and 20K contact each other.

In the lubricating-agent application mode, while all the image forming stations 10S, 10Y, 10C, 10M, and 10K are separated from the intermediate transfer belt 11 and the intermediate transfer belt 11 is rotated, the lubricating-agent applicator applies the lubricating agent to the surface of the intermediate transfer belt 11.

In the lubricating-agent application mode, the primary transfer rollers 62S, 62Y, 62C, 62M, and 62K are situated away from the photoconductors 20S, 20Y, 20C, 20M, and 20K by the contact-and-separation device 700. Accordingly, the intermediate transfer belt 11 and the photoconductors 20S, 20Y, 20C, 20M, and 20K are separated.

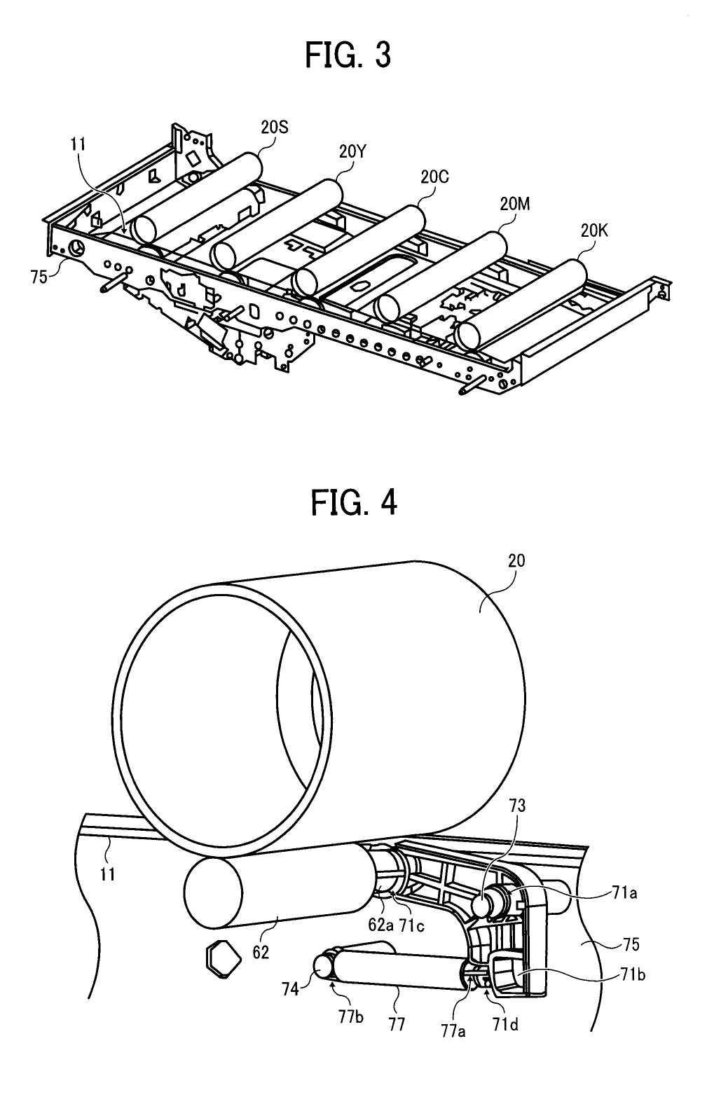

FIG. 3 is a perspective view schematically illustrating the intermediate transfer assembly 60 and the photoconductors 20S, 20Y, 20C, 20M, and 20K employed in the image forming apparatus 1 according to an illustrative embodiment of the present disclosure. As illustrated in FIG. 3, the intermediate transfer assembly 60 includes a support frame 75 that constitutes the housing of the intermediate transfer assembly 60. The support frame 75 of the intermediate transfer assembly 60, the intermediate transfer belt 11, and the photoconductors 20S, 20Y, 20C, 20M, and 20K are disposed in the image forming apparatus 1 in a manner illustrated in FIG. 3.

Next, with reference to FIGS. 4 and 5, a description is provided of a configuration that enables the primary transfer rollers 62S, 62Y, 62C, 62M, and 62K to contact the photoconductors 20S, 20Y, 20C, 20M, and 20K. It is to be noted FIGS. 4 and 5 illustrate one of the primary transfer rollers 62S, 62Y, 62C, 62M, and 62K, and one of the photoconductors 20S, 20Y, 20C, 20M, and 20K, as an example. For the sake of simplicity, the suffixes S, Y, C, M, and K indicating colors are omitted. FIG. 4 is an enlarged perspective view schematically illustrating one of primary transfer portions defined by the primary transfer roller 62 and the photoconductor 20 employed in the image forming apparatus 1. FIG. 5 is a partially enlarged cross-sectional view schematically illustrating the primary transfer portion as viewed from an axis of the primary transfer roller 62.

As illustrated in FIG. 5, the primary transfer roller 62 contacts the photoconductor 20 via the intermediate transfer belt 11 at the primary transfer portion. Furthermore, in the image forming apparatus 1, a roller support bracket 71 and a tension spring 77 are disposed at the primary transfer portion. The roller support bracket 71 is pivotable about a fulcrum shaft 73 fixed to the support frame 75. The tension spring 77 serves as a biasing member.

One end of the tension spring 77, that is, a first end 77a is hooked to a connecting portion 71d disposed at the bottom of the roller support bracket 71. The other end of the tension spring 77, that is, a second end 77b is hooked to a retainer pin 74 fixed to the support frame 75.

When a biasing force of the tension spring 77 acts in a direction of arrow A in FIG. 5, a rotational force acts on the roller support bracket 71 in a direction of arrow D2 with the fulcrum shaft 73 as the center of rotation. With this configuration, the primary transfer roller 62 moves in a direction of arrow D3 and comes in contact with the photoconductor 20.

The primary transfer roller 62 is rotatably supported by the roller support bracket 71 via a conductive shaft bearing 70. A swingable bias terminal 72 is fixed to the roller support bracket 71 in a state in which the swingable bias terminal 72 is electrically connected to the conductive shaft bearing 70, thereby forming a voltage application path from the swingable bias terminal 72 to the primary transfer roller 62.

The roller support bracket 71 is supported pivotally about the fulcrum shaft 73. As the roller support bracket 71 pivotally moves, the primary transfer roller 62 moves toward and away from the photoconductor 20.

The roller support bracket 71 is formed of resin having good sliding properties so that abrasion is reduced when contacting slidably the fulcrum shaft 73. Examples of the resin used for the roller support bracket 71 include, but are not limited to, acrylonitrile-butadiene-styrene copolymer (ABS), polyacetal (POM), polycarbonate (PC), and polyamide (PA).

FIG. 6 is a partially enlarged cross-sectional view schematically illustrating the primary transfer portion of FIG. 5, at which the primary transfer roller 62 is separated from the photoconductor 20.

As illustrated in FIG. 5, the image forming apparatus 1 includes the slider 78 including the pin 79 which is situated in an opening 71b of the roller support bracket 71.

As illustrated in FIG. 5, when forming an image, the slider 78 is situated such that the pin 79 does not contact the opening 71b of the roller support bracket 71. In this state, the biasing force of the tension spring 77 causes the primary transfer roller 62 to contact the photoconductor 20.

By contrast, when an image is not formed, the slider 78 is moved in a direction of arrow F in FIG. 6 by a driving force of a driving device such as a motor 701 illustrated in FIGS. 5 and 6 so that the pin 79 comes into contact with the opening 71b of the roller support bracket 71. Accordingly, a force acts on the roller support bracket 71 to rotate about the fulcrum shaft 73 in a direction of arrow D2′, thereby moving the primary transfer roller 62 in a direction of arrow D3′ to separate from the photoconductor 20.

The contact-and-separation device 700 includes the fulcrum shaft 73, the roller support bracket 71 supported by the fulcrum shaft 73, the slider 78 including the pin 79, the tension spring 77, and the motor 701. The contact-and-separation device 700 swingably moves the primary transfer roller 62 toward the photoconductor 20 in the direction of arrow D3 and away from the photoconductor 20 in the direction of arrow D3′.

If some kind of vibration transmits from the support frame 75 to the fulcrum shaft 73 and then to the primary transfer roller 62 via the roller support bracket 71 in this state, image defects such as banding may occur. For example, streaks formed of a visible pattern of light and dark at 4-mm intervals are generated in an output image when the linear velocity of the intermediate transfer belt is at 415 mm/s.

Various parts including drive parts and electronic parts in the image forming apparatus 1 may vibrate, and the vibration can transmit to the fulcrum shaft 73 via the support frame 75, hence shaking the fulcrum shaft 73. Generally, when such vibration occurs, the cause of vibration is specified to prevent transmission of the vibration to the roller support bracket 71 via the fulcrum shaft 73 and to prevent the support frame 75 from shaking.

However, the vibration that transmits to the roller support bracket 71 via the fulcrum shaft 73 has multiple frequencies with different sources of vibration. Thus, it takes time to specify the sources of each vibration and prevention measures, requiring complicated operations.

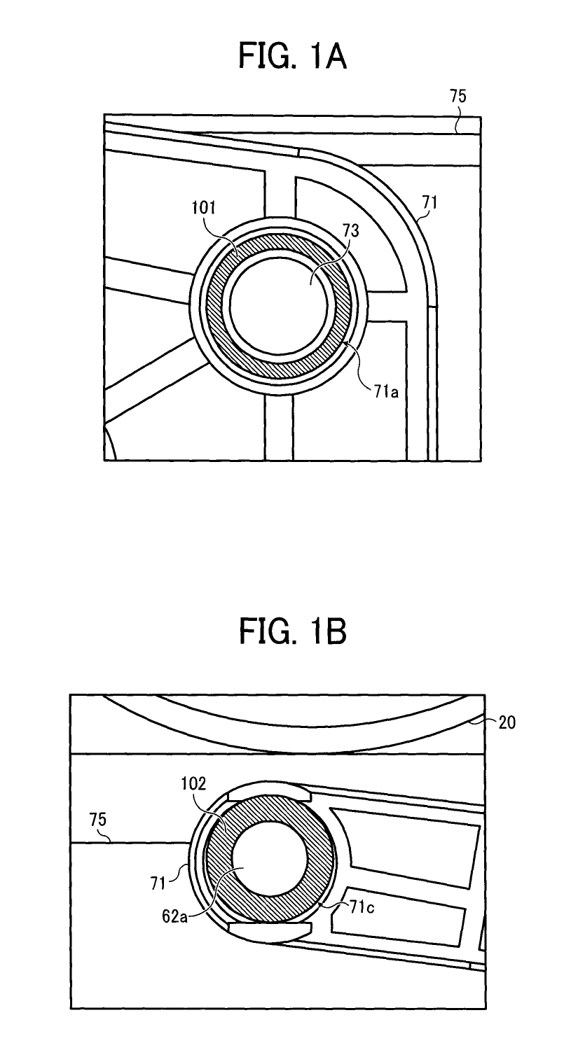

FIG. 1A is a schematic diagram illustrating a first vibration absorber 101 that absorbs vibration transmitted from the fulcrum shaft 73 to the roller support bracket 71 according to an illustrative embodiment of the present disclosure. FIG. 1B is a schematic diagram illustrating a second vibration absorber 102 that absorbs vibration transmitted from the roller support bracket 71 to a roller shaft 62a of the primary transfer roller 62.

According to the present illustrative embodiment, as illustrated in FIG. 1A, the roller support bracket 71 includes a first shaft hole 71a through which the fulcrum shaft 73 is inserted. The first vibration absorber 101 is disposed between an outer circumferential surface of the fulcrum shaft 73 and an inner circumferential surface of the first shaft hole 71a to absorb vibration transmitted from the fulcrum shaft 73 to the roller support bracket 71.

According to the present illustrative embodiment, as illustrated in FIG. 1B, the roller support bracket 71 includes a second shaft hole 71c through which the roller shaft 62a is inserted. The second vibration absorber 102 is disposed between an outer circumferential surface of the roller shaft 62a and an inner circumferential surface of the second shaft hole 71c to absorb vibration transmitted from the roller support bracket 71 to the roller shaft 62a.

With this configuration, the first vibration absorber 101 absorbs the vibration transmitted from the support frame 75 to the fulcrum shaft 73 before the vibration reaches the roller support bracket 71. Thus, with the first vibration absorber 101, the vibration of the roller support bracket 71 is reduced more than that without the first vibration absorber 101. Furthermore, the second vibration absorber 102 absorbs the vibration of the roller support bracket 71 before the vibration reaches the roller shaft 62a. Thus, with the second vibration absorber 102, the vibration of the roller shaft 62a is reduced more than that without the second vibration absorber 102.

With this configuration, the vibration transmitted to the primary transfer roller 62 can be reduced without complicated operation such as specifying the sources of vibration having a plurality of frequencies and countermeasures. The image defects derived from the vibration transmitted to the primary transfer roller 62 is suppressed, if not prevented entirely.

As the first vibration absorber 101 and the second vibration absorber 102, grease can be employed. More specifically, the space between the outer circumferential surface of the fulcrum shaft 73 and the inner circumferential surface of the first shaft hole 71a, and the space between the outer circumferential surface of the roller shaft 62a and the inner circumferential surface of the second shaft hole 71c are filled in with the grease. Alternatively, in some embodiments, the first vibration absorber 101 and the second vibration absorber 102 are cylindrical rubber bushings. In this configuration, the rubber bushing is fitted to the fulcrum shaft 73 and the roller shaft 62a. Still alternatively, the first vibration absorber 101 and the second vibration absorber 102 may employ any other suitable rubber.

Examples of the grease include, but are not limited to, BARRIERTA (registered trademark, manufactured by NOK corporation) having a kinematic viscosity of approximately 390 cSt (centistoke) at 40° C., NYOGEL 774VL (registered trademark, manufactured by Nye Lubricants, Inc.) having a kinematic viscosity of 597 cSt at 40° C., and NYOGEL 774 (registered trademark, manufactured by Nye Lubricants, Inc.) having a kinematic viscosity of 5548 cSt.

Preferably, the kinematic viscosity of the grease is in a range from 300 cSt and 7000 cSt at 40° C. With the kinematic viscosity lower than 300 cSt, the grease drips, which degrades absorption of vibration. By contrast, with the kinematic viscosity greater than 7000 cSt, operability of application of the grease is degraded.

The space (clearance) between the outer circumferential surface of the fulcrum shaft 73 and the inner circumferential surface of the first shaft hole 71a is equal to or greater than 0.05 mm and equal to or less than 0.10 mm. With this configuration, even when the space is filled in with the grease, the axial precision of the fulcrum shaft 73 is maintained reliably.

As described above, the second end 77b of the tension spring 77 is held by the retainer pin 74 fixed to the support frame 75 so that vibration transmits from the support frame 75 to the tension spring 77 via the retainer pin 74. As a result, the vibration transmitted to the tension spring 77 transmits to the roller support bracket 71 to which the first end 77a of the tension spring 77 is connected.

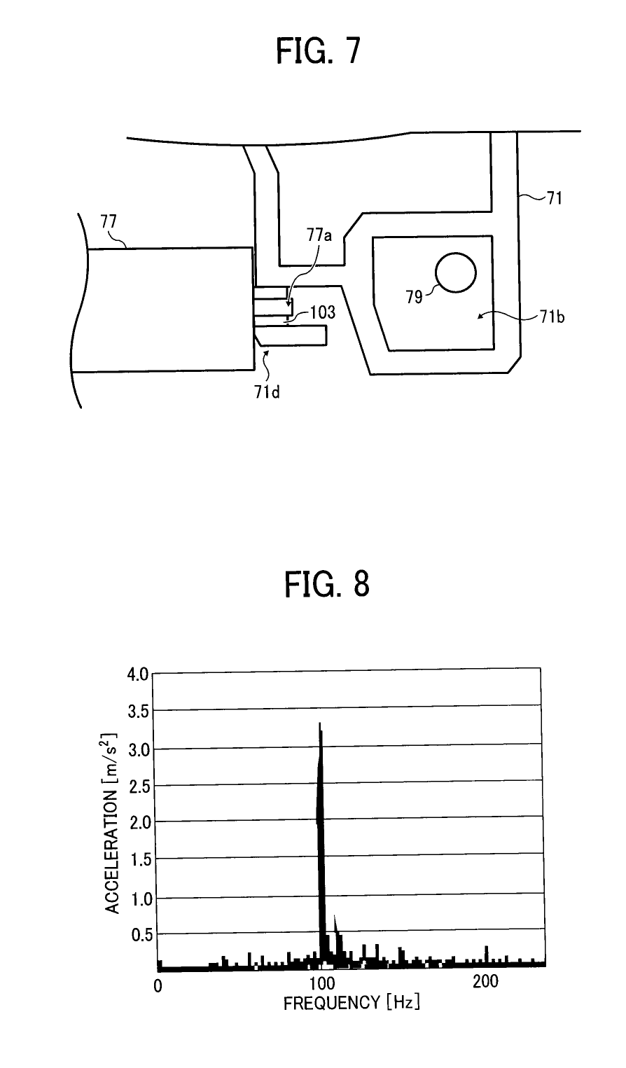

In view of the above, as illustrated in FIG. 7, a third vibration absorber 103 is disposed at a connecting portion at which the first end 77a of the tension spring 77 and the connecting portion 71d of the roller support bracket 71 contact. The third vibration absorber 103 absorbs vibration that transmits from the tension spring 77 to the roller support bracket 71.

For example, the above-described grease as the third vibration absorber 103 is applied between the first end 77a of the tension spring 77 and the connecting portion 71d of the roller support bracket 71, and the first end 77a and the connecting portion 71d are connected. Alternatively, in some embodiments, a portion of the connecting portion 71d of the roller support bracket 71 is covered with rubber as the third vibration absorber 103, and the first end 77a of the tension spring 77 is connected to the roller support bracket 71 via the rubber as the third vibration absorber 103.

With this configuration, the third vibration absorber 103 disposed at the connecting portion at which the first end 77a of the tension spring 77 and the connecting portion 71d of the roller support bracket 71 contact absorbs the vibration before the vibration transmitted to the tension spring 77 reaches the roller support bracket 71. With the third vibration absorber 103, the vibration of the roller support bracket 71 is reduced more than that without the third vibration absorber 103. The vibration that transmits from the roller support bracket 71 to the primary transfer roller 62 via the roller shaft 62a can be reduced more.

### Experiment

With reference to FIGS. 8 through 11, a description is provided of experiments performed by the present inventors. FIG. 8 is a graph showing measurement results of vibration of the roller support bracket 71. In the experiment, vibration of the roller support bracket 71 was measured when the intermediate transfer device was shaken at 105 Hz in a state in which the grease as the vibration absorber was not applied to the fulcrum shaft 73.

As can be understood from FIG. 8, the vibration of the roller support bracket 71 is significant at the time frequency of 105 Hz and the vibration acceleration is 3.3 m/s².

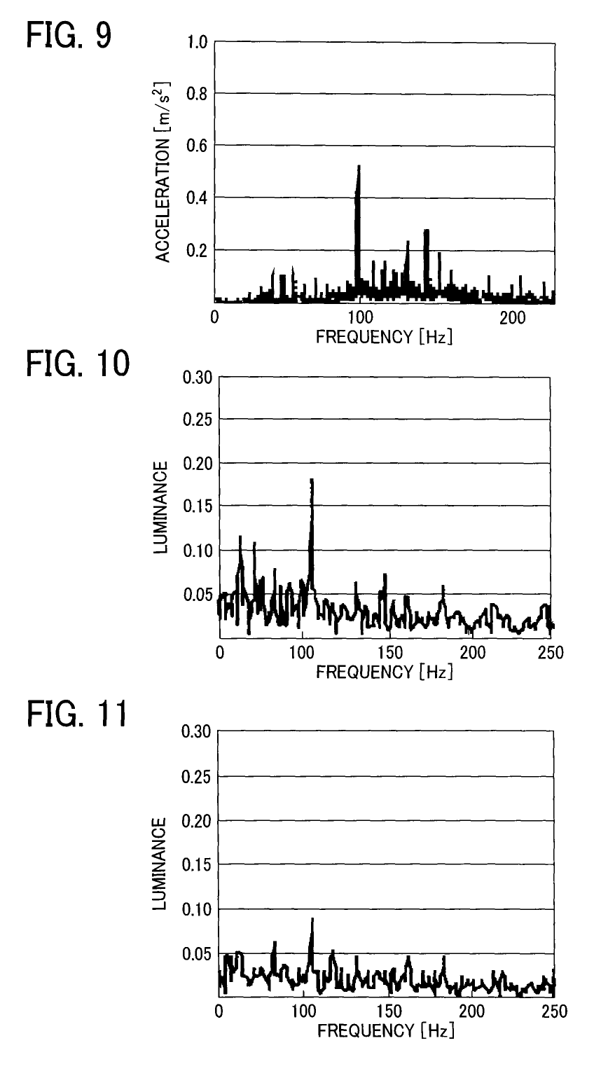

FIG. 9 is a graph showing measurement results of vibration of the roller support bracket when the intermediate transfer assembly 60 was shaken at 105 Hz in a state in which grease as the vibration absorber having a kinematic viscosity of 390 cSt (centistoke) at 40° C. was applied to the fulcrum shaft 73, and vibration of the roller support bracket 71 was measured. It is to be noted that the space (clearance) between the outer circumferential surface of the fulcrum shaft 73 and the inner circumferential surface of the first shaft hole 71a was approximately 0.1 mm, and the space was filled in with the grease in the amount of approximately 100 mg.

In a case in which the space between the outer circumferential surface of the fulcrum shaft 73 and the inner circumferential surface of the first shaft hole 71a is filled in with the grease, as illustrated in FIG. 9, the vibration acceleration is 0.52 m/s² at the time frequency of 105 Hz. The vibration acceleration is approximately 1/7 of the vibration acceleration shown in FIG. 8. This indicates that vibration is reduced significantly.

FIG. 10 is a graph showing a fast Fourier transform (FFT) analysis of changes in luminance of an output image when the intermediate transfer assembly 60 is shaken at 105 Hz in a state in which the grease is not applied to the fulcrum shaft 73.

By contrast, FIG. 11 shows a graph showing a fast Fourier transform (FFT) analysis of changes in luminance of an output image when the intermediate transfer assembly 60 is shaken at 105 Hz in a state in which the grease is applied to the fulcrum shaft 73.

As can be understood from FIGS. 10 and 11, the vibration acceleration is reduced from 0.19 m/s² to 0.08 m/s² at the time frequency of 105 Hz, which means that the vibration acceleration is reduced by half with application of the grease to the fulcrum shaft 73 to reduce the vibration of the roller support bracket 71. Furthermore, it is understood that changes in luminance are reduced in other frequency components.

According to the present illustrative embodiment, the image forming apparatus employs a transfer assembly (intermediate transfer assembly) using the intermediate transfer method in which toner images on the photoconductors are transferred primarily onto the intermediate transfer belt one atop the other, and then the thus obtained composite toner image is transferred onto a recording medium as described above. However, the image forming apparatus is not limited to this. Alternatively, the present disclosure can be also applied to an image forming apparatus that employs a transfer assembly using a direct transfer method in which toner images on the photoconductors are transferred directly onto a recording medium one atop the other.

Although the embodiment of the present disclosure has been described above, the present disclosure is not limited to the foregoing embodiments, but a variety of modifications can naturally be made within the scope of the present disclosure.

### Aspect A

A transfer assembly such as the intermediate transfer assembly 60 includes a belt such as the intermediate transfer belt 11 formed into an endless loop facing an image bearer such as the photoconductors 20S, 20Y, 20C, 20M, and 20K bearing a toner image to rotate, a transfer device such as the primary transfer rollers 62S, 62Y, 62C, 62M, and 62K to contact the image bearer via the belt to form a transfer nip portion between the image bearer and the belt and to transfer the toner image onto one of a surface of the belt and a recording medium carried on the surface of the belt, a retainer such as the roller support bracket 71 supported by a swingable shaft such as the fulcrum shaft 73 to hold the transfer device pivotally movable in a first direction in which the transfer device approaches the image bearer and in a second direction opposite to the first direction in which the transfer device separates from the image bearer, a contact-and-separation device 700 to move the transfer device to contact and separate from the image bearer, and a vibration absorber such as the first vibration absorber 101 and the second vibration absorber 102 to absorb vibration transmitted from the swingable shaft to the transfer device via the retainer.

According to Aspect A, the vibration absorber absorbs vibration transmitted from the shaft to the retainer. With the vibration absorber, the vibration that transmits to the transfer device is reduced more than that without the vibration absorber.

With this configuration, image defects derived from the vibration of the transfer device can be prevented without complicated operations such as specifying the sources of vibration having a plurality of frequencies that may cause image defects, and countermeasures.

### Aspect B

According to Aspect A, the retainer includes a shaft hole such as the first shaft hole 71a through which the swingable shaft is inserted, and the vibration absorber is disposed between an outer circumferential surface of the swingable shaft and an inner circumferential surface of the shaft hole.

With this configuration, as described above, the vibration transmitting from the shaft to the retainer can be reduced.

### Aspect C

According to Aspect A or Aspect B, the transfer device is a roller rotatable about a rotary shaft such as the roller shaft 62a, and the retainer includes a rotary shaft hole such as the second shaft hole 71c through which the rotary shaft is inserted. The vibration absorber is disposed between an outer circumferential surface of the rotary shaft and inner circumferential surface of the rotary shaft hole.

With this configuration, as described above, the vibration transmitting from the retainer to the transfer roller via the rotary shaft the shaft can be reduced.

### Aspect D

According to any one of Aspects A through C, the vibration absorber is a grease. With this configuration, as described above, low cost and improved operability can be achieved.

### Aspect E

According to Aspect D, a kinematic viscosity of the grease is not less than 300 cSt (centistoke) and not greater than 7000 cSt (centistoke) at a temperature of 40° C. As described above, this configuration prevents the grease from dripping, thereby enhancing absorption of vibration and facilitating application of the grease.

### Aspect F

According to any one of Aspects A through C, the vibration absorber is a rubber. With this configuration, as described above, the vibration can be absorbed with an easy configuration.

### Aspect G

According to any one of Aspects A through F, the retainer is formed of a resin material having slidable properties. With this configuration, as described above, abrasion of the retainer is prevented.

### Aspect H

According to any one of Aspects A through G, the transfer device includes a biasing device such as the tension spring 77 to bias the retainer in the first direction and a second vibration absorber such as the third vibration absorber 103 disposed at a connecting portion at which the biasing device and the retainer are connected, to absorb vibration transmitted from the biasing device to the retainer.

With this configuration, as described above, the vibration transmitting from the biasing device to the retainer can be reduced.

### Aspect I

According to Aspect H, the second vibration absorber is formed of one of a grease and a rubber. With this configuration, as described above, the vibration can be absorbed with an easy configuration.

### Aspect J

An image forming apparatus includes an image bearer on which a toner image is formed and the transfer device according to any one of Aspects A through I to transfer the toner image from the image bearer onto a recording medium. With this configuration, as described above, the vibration transmitting from the shaft to the retainer can be reduced, hence preventing image defects derived from vibration of the transfer device. Good imaging is performed.

According to an aspect of this disclosure, the present invention is employed in the image forming apparatus. The image forming apparatus includes, but is not limited to, an electrophotographic image forming apparatus, a copier, a printer, a facsimile machine, and a digital multi-functional system.

Furthermore, it is to be understood that elements and/or features of different illustrative embodiments may be combined with each other and/or substituted for each other within the scope of this disclosure and appended claims. In addition, the number of constituent elements, locations, shapes and so forth of the constituent elements are not limited to any of the structure for performing the methodology illustrated in the drawings.

Example embodiments being thus described, it will be obvious that the same may be varied in many ways. Such exemplary variations are not to be regarded as a departure from the scope of the present invention, and all such modifications as would be obvious to one skilled in the art are intended to be included within the scope of the following claims.

What is claimed is:

1. A transfer assembly, comprising:
a belt formed into an endless loop facing an image bearer bearing a toner image, to rotate;
a transfer device to contact the image bearer via the belt to form a transfer nip portion between the image bearer and the belt and to transfer the toner image onto one of a surface of the belt and a recording medium carried on the surface of the belt;
a contact-and-separation device to move the transfer device to contact and separate from the image bearer, the contact-and-separation device including a retainer pivotally supported by a swingable shaft and movable in a first direction in which the transfer device approaches the image bearer and in a second direction opposite to the first direction in which the transfer device separates from the image bearer, to hold the transfer device; and
a first vibration absorber to absorb vibration transmitted from the swingable shaft to the transfer device via the retainer.

2. The transfer assembly according to claim 1, wherein the retainer includes a shaft hole through which the swingable shaft is inserted, and the first vibration absorber is disposed between an outer circumferential surface of the swingable shaft and an inner circumferential surface of the shaft hole.

3. The transfer assembly according to claim 1, wherein the transfer device is a roller rotatable about a rotary shaft, and the retainer includes a rotary shaft hole through which the rotary shaft is inserted,
wherein the first vibration absorber is disposed between an outer circumferential surface of the rotary shaft and inner circumferential surface of the rotary shaft hole.

4. The transfer assembly according to claim 1, wherein the first vibration absorber includes grease.

5. The transfer assembly according to claim 4, wherein the grease has a kinematic viscosity of not less than 300 cSt (centistoke) and not greater than 7000 cSt at a temperature of 40° C.

6. The transfer assembly according to claim 1, wherein the first vibration absorber includes rubber.

7. The transfer assembly according to claim 1, wherein the retainer is formed of resin having sliding properties.

8. The transfer assembly according to claim 1, further comprising:
a biasing device to bias the retainer in the first direction; and
a second vibration absorber disposed at a connecting portion at which the biasing device and the retainer are connected, to absorb vibration transmitted from the biasing device to the retainer.

9. The transfer assembly according to claim 8, wherein the second vibration absorber includes one of grease and rubber.

10. An image forming apparatus, comprising:
an image bearer on which an image is formed;
the transfer assembly according to claim 1 to transfer the image from the image bearer onto a recording medium.

11. An image forming apparatus, comprising:
an image bearer to bear a toner image on a surface of the image bearer;
a belt;
a transfer roller to contact a rear surface of the belt to transfer the toner image from the image bearer onto a front surface of the belt;
a swingable shaft; and
a bracket including a shaft hole through which the swingable shaft is inserted, to hold the transfer roller pivotally about the swingable shaft such that the transfer roller is pivotally movable between a contact position at which the transfer roller contacts the rear surface of the belt and a separating position at which the transfer roller is separated from the belt,
wherein a space between an outer circumferential surface of the swingable shaft and an inner circumferential surface of the shaft hole is filled in which grease.

12. The image forming apparatus according to claim 11, wherein the grease has a kinematic viscosity of not less than 300 cSt (centistoke) and not greater than 7000 cSt.

13. The image forming apparatus according to claim 11, wherein the space between the outer circumferential surface of the swingable shaft and the inner circumferential surface of the shaft hole is 0.10 mm or less.

14. The image forming apparatus according to claim 11, further comprising a contact-and-separation device to move the transfer roller to contact and separate from the rear surface of the belt.

15. The image forming apparatus according to claim 14, wherein the contact-and-separation device includes a slider that contacts the bracket to pivotally move the bracket about the swingable shaft.

16. An image forming apparatus, comprising:
an image bearer to bear a toner image on a surface of the image bearer;
a belt;
a transfer roller to contact a rear surface of the belt to transfer the toner image from the image bearer onto a front surface of the belt;
a swingable shaft;
a bracket including a shaft hole through which the swingable shaft is inserted, to hold the transfer roller pivotally about the swingable shaft such that the transfer roller is pivotally movable between a contact position at which the transfer roller contacts the rear surface of the belt and a separating position at which the transfer roller is separated from the belt; and
a rubber bushing disposed between an outer circumferential surface of the swingable shaft and an inner circumferential surface of the shaft hole.

17. The image forming apparatus according to claim 16, wherein the rubber is tubular.

18. The image forming apparatus according to claim 16, further comprising a contact-and-separation device to move the transfer roller to contact and separate from the rear surface of the belt.

19. The image forming apparatus according to claim 18, wherein the contact-and-separation device includes a slider that contacts the bracket to pivotally move the bracket about the swingable shaft.
